(19) United States
(12) Patent Application Publication
(10) Pub. No.: US 2020/0125920 A1
(43) Pub. Date: Apr. 23, 2020

(54) INTERACTION METHOD AND APPARATUS OF VIRTUAL ROBOT, STORAGE MEDIUM AND ELECTRONIC DEVICE

(71) Applicant: CLOUDMINDS (SHENZHEN) ROBOTICS SYSTEMS CO., LTD., Shenzhen (CN)

(72) Inventors: Zhaoxiang LIU, Shenzhen (CN); Shiguo LIAN, Shenzhen (CN); Ning WANG, Shenzhen (CN)

(21) Appl. No.: 16/568,540

(22) Filed: Sep. 12, 2019

(30) Foreign Application Priority Data
Oct. 18, 2018 (CN) 201811217722.7

(51) Int. Cl. G06N 3/00; G06K 9/00

(52) U.S. Cl. CPC G06N 3/006; G06K 9/00315; G06K 9/00342; G06N 3/008

(57) ABSTRACT

An interaction method and apparatus of a virtual robot, a storage medium and an electronic device, includes obtaining interaction information input by a user for interacting with the virtual robot; inputting the interaction information into a control model of the virtual robot, wherein the control model is obtained by training by using interaction information input by a user of a live video platform and behavior response information of an anchor for the interaction information as model training samples; and performing behavior control on the virtual robot according to behavior control information output by the control model based on the interaction information. The method achieves the interaction between the virtual robot and the user, improving the instantaneity, the flexibility and the applicability of the virtual robot, and meeting the emotional and action communication demands of the user and the virtual robot.

### CROSS-REFERENCE TO RELATED APPLICATION

This application claims priority from Chinese Patent Application No. 201811217722.7, filed on Oct. 18, 2018, which is herein incorporated by reference in its entirety.

### FIELD OF THE INVENTION

The present disclosure relates to the field of human-computer interaction, and in particular to an interaction method and apparatus of a virtual robot, a storage medium and an electronic device.

### BACKGROUND OF THE INVENTION

At present, virtual idols have become a new bright spot in the entertainment field, and are gradually loved and sought after by people. However, the traditional virtual idols are mainly pre-implemented based on preset characters, plots, interaction modes and other elements of systems, thus real-time interaction with the audiences cannot be achieved and the flexibility and applicability are relatively low.

With the development of live streaming industry, users can watch live stream on live streaming platforms, interact with the live streaming via texts, and can also give virtual gifts to anchor(s) of the live streaming, the existing virtual idol technology cannot be applied to the live streaming platforms to achieve live stream, and the functions of traditional auxiliary robots in live rooms are also relatively simple and are mainly based on voice, thus cannot satisfy the emotional communication and action exchange experience of people.

### SUMMARY OF THE INVENTION

The main purpose of the present disclosure is to provide an interaction method and apparatus of a virtual robot, a storage medium and an electronic device, in order to solve the problems in the related art described above.

In order to achieve the above purpose, a first aspect of embodiments of the present disclosure provides an interaction method of a virtual robot, comprising:

obtaining interaction information input by a user for interacting with the virtual robot;

inputting the interaction information into a control model of the virtual robot, wherein the control model is obtained by training by using interaction information input by a user of a live video platform and behavior response information of an anchor for the interaction information as model training samples; and performing behavior control on the virtual robot according to behavior control information output by the control model based on the interaction information.

Optionally, the method further comprises: a method for training the control model, including: obtaining the interaction information input by the user and the behavior response information of the anchor for the interaction information from the live video platform; and using the interaction information input by the user and the behavior response information of the anchor for the interaction information obtained from the live video platform as model training samples to train the control model.

Optionally, the obtaining the behavior response information of the anchor for the interaction information input by the user from the live video platform comprises:

extracting body movement information of the anchor from an anchor video according to a human body posture parsing module; and/or extracting facial expression information of the anchor from the anchor video according to a facial expression analysis module; and/or extracting voice information of the anchor from an anchor audio according to a voice analysis module.

Optionally, the control model includes a deep learning network, the deep learning network is divided into three branches by a convolutional network and a fully connected layers, that is, body movement output, facial expression output and voice output; the interaction information input by the user in the live video platform includes text information input by the user into a live chat room and picture information of a virtual gift given by the user to the anchor, and the behavior response information includes body movement information, facial expression information and voice information of the anchor.

The using the interaction information input by the user and the behavior response information of the anchor for the interaction information obtained from the live video platform as model training samples to train the control model includes:

using the text information and the picture information of the virtual gift as training inputs to train body movements, facial expressions and voice of the virtual robot.

Optionally, before the obtaining interaction information input by a user for interacting with the virtual robot, the method further comprises:

obtaining preference information input by the user; and

determining a target control model matching the preference information from multiple types of control models of the virtual robot;

the inputting the interaction information into a control model of the virtual robot includes: inputting the interaction information into the target control model; and

the performing behavior control on the virtual robot according to behavior control information output by the control model based on the interaction information includes:

performing behavior control on the virtual robot according to the behavior control information output by the target control model based on the interaction information.

A second aspect of the embodiments of the present disclosure provides an interaction apparatus of a virtual robot, including:

a first obtaining module configured to obtain interaction information input by a user for interacting with the virtual robot;

a model input module configured to input the interaction information into a control model of the virtual robot, wherein the control model is obtained by training by using interaction information input by a user of a live video platform and behavior response information of an anchor for the interaction information as model training samples; and

a control module configured to perform behavior control on the virtual robot according to behavior control information output by the control model based on the interaction information.

Optionally, the apparatus further comprises:

a second obtaining module configured to obtain the interaction information input by the user and the behavior response information of the anchor for the interaction information from the live video platform; and

a model training module configured to use the interaction information input by the user and the behavior response information of the anchor for the interaction information obtained from the live video platform as model training samples to train the control model.

Optionally, the second obtaining module includes:

a first obtaining sub-module configured to extract body movement information of the anchor from an anchor video according to a human body posture parsing module; and/or

a second obtaining sub-module configured to extract facial expression information of the anchor from the anchor video according to a facial expression analysis module; and/or

a third obtaining sub-module configured to extract voice information of the anchor from an anchor audio according to a voice analysis module.

Optionally, the control model includes a deep learning network, the deep learning network is divided into three branches by a convolutional network and a fully connected layers, that is, body movement output, facial expression output and voice output; the interaction information input by the user in the live video platform includes text information input by the user into a live chat room and picture information of a virtual gift given by the user to the anchor, and the behavior response information includes body movement information, facial expression information and voice information of the anchor.

The model training module configured to use the text information and the picture information of the virtual gift as training inputs to train body movements, facial expressions and voice of the virtual robot.

Optionally, apparatus further includes:

a third obtaining module configured to obtain preference information input by the user; and

a determining module configured to determine a target control model matching the preference information from multiple types of control models of the virtual robot;

the model input module configured to input the interaction information into the target control model; and

the control module configured to perform behavior control on the virtual robot according to the behavior control information output by the target control model based on the interaction information.

A third aspect of the embodiments of the present disclosure provides a computer readable storage medium, a computer program is stored thereon, and the program implements the steps of the method of the first aspect when being executed by a processor.

A fourth aspect of the embodiments of the present disclosure provides an electronic device, including:

a memory, wherein a computer program is stored thereon; and

a processor configured to execute the computer program in the memory to implement the steps of the method of the first aspect.

By adoption of the above technical solutions, at least the following technical effects can be achieved: historical data of the live video platform, including: the interaction information input by the user and the behavioral response information of the anchor for the interaction information, are used as the model training samples for training to obtain the control model, and the output of the control model is control information for controlling the behavior of the virtual robot. In this way, based on the control model, by collecting the interaction information input by the user for interacting with the virtual robot in real time, real-time interaction response control with the user of the virtual robot can be realized, the instantaneity, the flexibility and the applicability of the virtual robot are improved, and the emotional and action communication demands of the user and the virtual robot are met.

Other features and advantages of the present disclosure will be described in detail in the following detailed description.

### BRIEF DESCRIPTION OF THE DRAWINGS

The drawings are used for providing a further understanding of the present disclosure and constitute a part of the specification. The drawings, together with the following specific embodiments, are used for illustrating the present disclosure, but are not intended to limit the present disclosure. In the drawings:

FIG. 1 is a schematic flow diagram of an interaction method of a virtual robot provided by an embodiment of the present disclosure;

FIG. 2 is a schematic flow diagram of a method for training a control model of a virtual robot provided by an embodiment of the present disclosure;

FIG. 3 is a schematic diagram of one control model training process provided by an embodiment of the present disclosure;

FIG. 4 is a schematic diagram of another control model training process provided by an embodiment of the present disclosure;

FIG. 5 is a structural schematic diagram of an interaction apparatus of a virtual robot provided by an embodiment of the present disclosure;

FIG. 6 is a structural schematic diagram of an interaction apparatus of a virtual robot provided by an embodiment of the present disclosure;

FIG. 7 is a structural schematic diagram of another training apparatus of a virtual robot provided by an embodiment of the present disclosure;

FIG. 8 is a structural schematic diagram of yet another electronic device provided by an embodiment of the present disclosure.

### DETAILED DESCRIPTION OF THE EMBODIMENTS

The specific embodiments of the present disclosure will be described in detail below in combination with the drawings. It should be understood that the specific embodiments described herein are merely used for illustrating and explaining the present disclosure, rather than limiting the present disclosure.

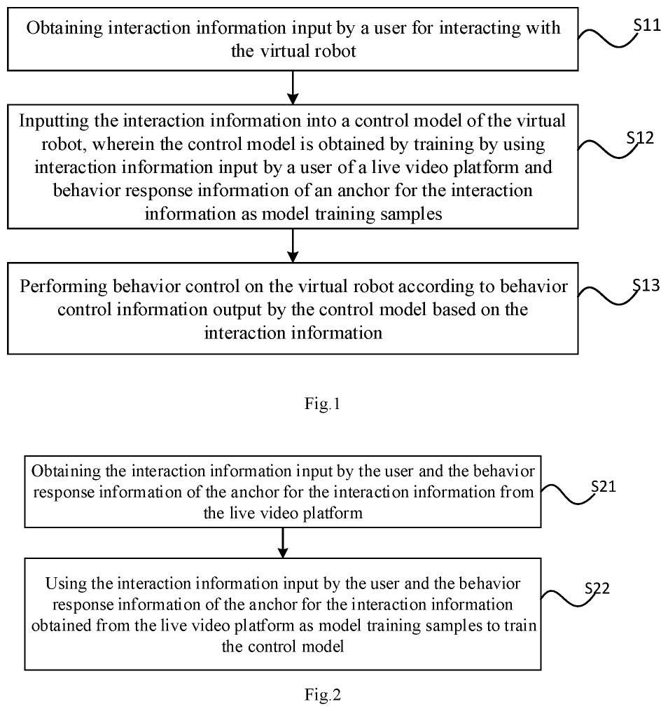

The embodiment of the present disclosure provides an interaction method of a virtual robot, as shown in FIG. 1, the method comprises:

S11. interaction information input by a user for interacting with the virtual robot is obtained.

In a possible implementation manner, according to the embodiment of the present disclosure, the animation technology can be combined with the live streaming technology to display an animated image of a virtual character in a live stream room, and the interaction information input by the user can be text information input by the user in the live room of the virtual robot and/or picture information of a gift given by the user, etc.

The foregoing description is only an example of a possible application scenario of the embodiment of the present disclosure. In another possible implementation manner, the virtual robot may not be applied to the live streaming, but is built in a separate terminal product to serve as a chatting robot or an emotional interaction robot for production and sales. This is not limited in the present disclosure.

S12. the interaction information is input into a control model of the virtual robot, wherein the control model is obtained by training by using the interaction information input by the user of a live video platform and behavior response information of an anchor for the interaction information as model training samples.

Specifically, based on the historical playing information of the live video platform, mass samples can be obtained, the text information input by the audience in a chat room of each anchor's live room and the picture information of the given virtual gift can be used as the above interaction information, moreover, the behavior response information of the anchor can be extracted from the video and audio of the anchor, therefore mass model training samples can be obtained, and accordingly, the control of the control model obtained by the training on the virtual robot is closer to the real response of the anchor.

S13. behavior control is performed on the virtual robot according to behavior control information output by the control model based on the interaction information.

Specifically, the behavior control of the virtual robot can include the control of body movements, facial expressions and voice outputs of the virtual robot displayed in animated images.

By adoption of the above method, historical playing data of the live video platform, including the interaction information input by the user and the behavioral response information of the anchor for the interaction information, are used as the model training samples for training to obtain the control model, and the output of the control model is control information for controlling the behavior of the virtual robot. In this way, based on the control model, by collecting the interaction information input by the user for interacting with the virtual robot in real time, real-time interaction response control with the user of the virtual robot can be realized, the instantaneity, the flexibility and the applicability of the virtual robot are improved, and the emotional and action communication demands of the user and the virtual robot are met.

In order to make those skilled in the art better understand the technical solutions provided by the embodiment of the present disclosure, the interaction method of the virtual robot provided by the embodiment of the present disclosure is described in detail below.

Firstly, for the control model described in the step S12, the embodiment of the present disclosure further includes a training method of the control model, it is worth noting that the training of the control model is performed in advance according to the samples collected from the live video platform. In the subsequent interaction process between the virtual robot and a user, it is not necessary to train the control model every time, or the control model can be updated periodically based on the newly collected samples from the live video platform.

Specifically, the training method of the control model of the virtual robot, as shown in FIG. 2, includes:

S21. interaction information input by a user and the behavior response information of the anchor for the interaction information are obtained from the live video platform.

For example, the interaction information input by the user on the live video platform includes text information input by the user into a live chat room and picture information of a virtual gift given by the user to the anchor.

S22. the interaction information input by the user and the behavior response information of the anchor for the interaction information obtained from the live video platform are used as model training samples to train the control model.

The approaches of obtaining the behavior response information of the anchor are described below:

Approach 1: body movement information of the anchor is extracted from an anchor video according to a human body posture parsing module.

The body movement information is mainly position information of limb joint(s). The input of the human body posture parsing module is continuous image frame(s), a probability graph of the posture is obtained through convolutional neural network learning, then an intermediate mixed probability distribution map is generated in combination with optical flow information, and finally, the position information of the joint can be obtained.

Approach 2: facial expression information of the anchor is extracted from the anchor video according to a facial expression analysis module.

Specifically, a face area can be extracted from the anchor video through a face detection module, and then an expression classification result is generated through deep neural network learning.

Approach 3: voice information of the anchor is extracted from anchor audio according to a voice analysis module.

Firstly, a sentence is converted into an image to serve as input, that is, Fourier transform is performed on each frame of voice at first, then time and frequency are taken as two dimensions of the image, then modeling is performed on the whole sentence through a convolutional network, and an output unit directly corresponds to a final recognition result such as a syllable or a Chinese character.

It is worth noting that, the foregoing three implementation approaches can be selectively implemented according to actual requirements (for example, product function design), that is, in the step S21, the obtaining the behavior response information of the anchor for the interaction information input by the user from the live video platform includes: extracting the body movement information of the anchor from the anchor video according to the human body posture parsing module; and/or, extracting the facial expression information of the anchor from the anchor video according to the facial expression analysis module; and/or, extracting the voice information of the anchor from anchor audio according to the voice analysis module.

The training of the control model is illustrated below by taking it as an example that the interaction information input by the user on the video live platform includes the text information input by the user into the live chat room and the picture information of the virtual gift given by the user to the anchor, and the behavior response information includes the body movement information, the facial expression information and the voice information of the anchor.

Specifically, the control model includes a deep learning network, the deep learning network is divided into three branches by a convolutional network and a fully connected layers, that is, body movement output, facial expression output and voice output, then, the using the interaction information input by the user and the behavior response information of the anchor for the interaction information obtained from the live video platform as model training samples to train the control model includes: using the text information and the picture information of the virtual gift as training inputs to train body movements, facial expressions and voice of the virtual robot.

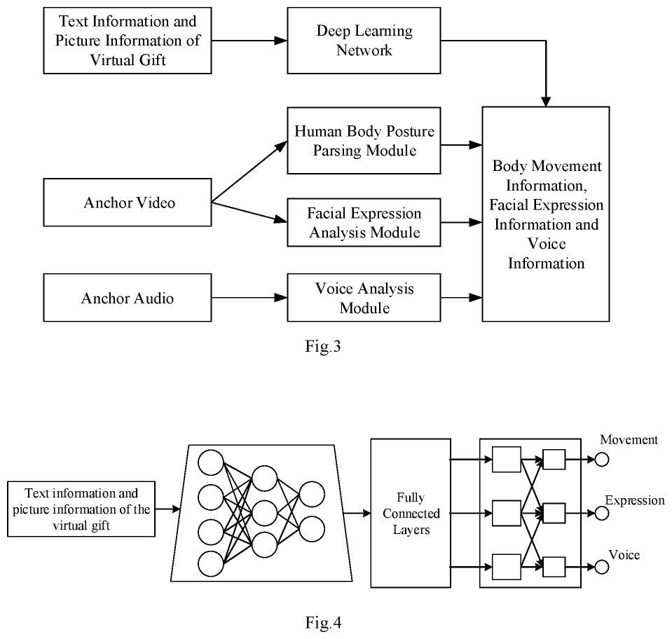

Exemplarily, FIG. 3 and FIG. 4 show schematic diagrams of training of the control model, respectively. FIG. 3 shows the source of training data, and FIG. 4 shows a training process of the control model according to the deep learning network. As shown in FIG. 3, the text information and the gift picture are used as input samples of the deep learning network, and the body movement information and the facial expression information extracted from the anchor video according to the human body posture parsing module and the facial expression analysis module, and the voice information extracted from the anchor audio according to the voice analysis module are used as output samples marked by the deep learning network. As shown in FIG. 4, the deep neural network is divided into three branches by the convolutional network and the fully connected layers, that is, body movement output, facial expression output and voice output, so as to train the body movements, the facial expressions and the voice of the virtual robot.

It is worth noting that, the human body posture parsing, the facial expression analysis and the voice analysis can all be implemented by the neural network in a deep learning manner.

In a possible implementation manner of the embodiment of the present disclosure, before the interaction between the user and the virtual robot, the user can be allowed to select the virtual robot according to his/her own preference. Exemplarily, before the step S11, preference information input by the user can be obtained, and a target control model matching the preference information is determined from multiple types of control models of the virtual robot, wherein the multiple types of control models can be control models trained by collecting data according to different personality types of anchors; correspondingly, the step S12 includes: inputting the interaction information into the target control model; and the step S13 includes: performing behavior control on the virtual robot according to the behavior control information output by the target control model based on the interaction information.

The preference information can be target tag information selected by the user in the tag information for the selection of the user, and the tag information can be, for example, an anchor personality tag, an anchor performance style tag, or the like.

For example, in the embodiment of the present disclosure, the anchors can be classified according to the personality tag, the performance style tag and the like presented for each anchor on the live video platform, and the control model is respectively trained in advance according to the historical playing information of each type of anchors for the user to input the preference information for selection. Therefore, the interaction between the virtual robot and the user can be implemented based on the preference of the user, which is equivalent to realizing the customization of the personality of the virtual robot by the user, so that the user experience is improved. During specific implementation, the appearance of the virtual robot can also be customized according to the preference of the user, which is not limited in the present disclosure.

Based on the same inventive concept, the present disclosure further provides an interaction apparatus of a virtual robot, which is used for implementing the interaction method of the virtual robot provided by the foregoing method embodiment. As shown in FIG. 5, the apparatus comprises:

a first obtaining module 51 configured to obtain interaction information input by a user for interacting with the virtual robot;

a model input module 52 configured to input the interaction information into a control model of the virtual robot, wherein the control model is obtained by training by using interaction information input by a user of a live video platform and behavior response information of an anchor for the interaction information as model training samples; and

a control module 53 configured to perform behavior control on the virtual robot according to behavior control information output by the control model based on the interaction information.

By adoption of the above apparatus, historical playing data of the live video platform, including: the interaction information input by the user and the behavioral response information of the anchor for the interaction information, are used as the model training samples for training to obtain the control model, and the output of the control model is control information for controlling the behavior of the virtual robot. In this way, based on the control model, by collecting the interaction information input by the user for interacting with the virtual robot in real time, real-time interaction response control with the user of the virtual robot can be realized, the instantaneity, the flexibility and the applicability of the virtual robot are improved, and the emotional and action communication demands of the user and the virtual robot are met.

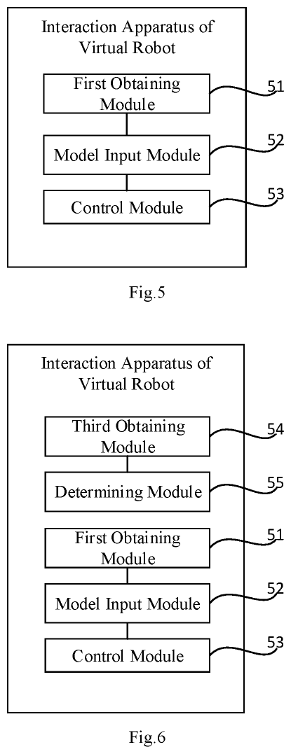

Optionally, as shown in FIG. 6, the apparatus further comprises:

a third obtaining module 54 configured to obtain preference information input by the user; and

a determining module 55 configured to determine a target control model matching the preference information from multiple types of control models of the virtual robot;

the model input module 52 configured to input the interaction information into the target control model;

the control module 53 configured to perform behavior control on the virtual robot according to the behavior control information output by the target control model based on the interaction information.

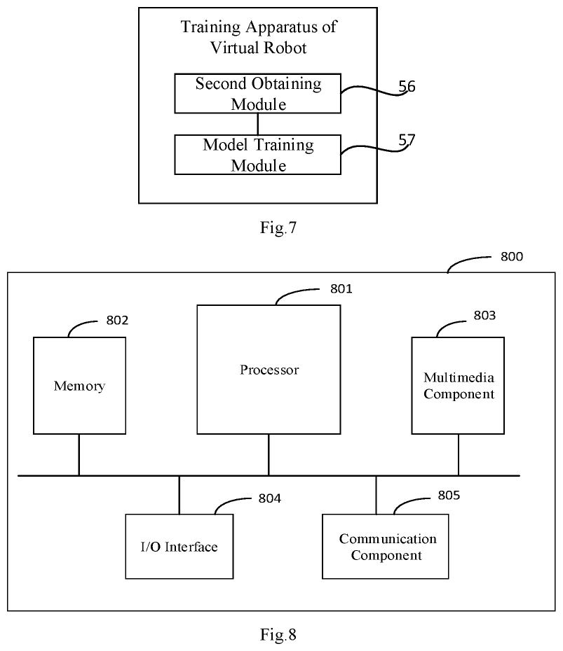

The present disclosure further provides a training apparatus of the virtual robot for implementing the training method of the virtual robot provided in FIG. 2. As shown in FIG. 7, the apparatus comprises:

a second obtaining module 56 configured to obtain the interaction information input by the user and the behavior response information of the anchor for the interaction information from the live video platform; and a model training module 57 configured to use the interaction information input by the user and the behavior response information of the anchor for the interaction information obtained from the live video platform as model training samples to train the control model. Exemplarily, the interaction information input by the user on the live video platform includes text information input by the user into the live chat room and/or picture information of the virtual gift given by the user to the anchor.

Optionally, the second obtaining module 56 can include:

a first obtaining sub-module configured to extract body movement information of the anchor from an anchor video according to a human body posture parsing module; and/or

a second obtaining sub-module configured to extract facial expression information of the anchor from the anchor video according to a facial expression analysis module; and/or

a third obtaining sub-module configured to extract voice information of the anchor from anchor audio according to a voice analysis module.

Optionally, the control model includes a deep learning network, the deep learning network is divided into three branches by a convolutional network and a fully connected layers, that is, body movement output, facial expression output and voice output; the interaction information input by the user in the live video platform includes the text information input by the user into the live chat room and the picture information of the virtual gift given by the user to the anchor, and the behavior response information includes body movement information, facial expression information and voice information of the anchor.

The model training module 57 configured to use the text information and the picture information of the virtual gift as training inputs to train body movements, facial expressions and voice of the virtual robot.

It is worth noting that, the interaction apparatus and the training apparatus of the virtual robot provided above can be separately set and can also be integrated into the same server, for example, the interaction apparatus and the training apparatus implement a part of or all of the server in software, hardware or a combination of the two, and this is not limited in the present disclosure.

With regard to the apparatus in the above embodiment, the specific manners of the modules to execute operations have been described in detail in the embodiments related to the method, and thus is not explained in detail herein.

The embodiment of the present disclosure further provides a computer readable storage medium, a computer program is stored thereon, and the program implements the steps of the interaction method of the virtual robot when being executed by a processor.

The embodiment of the present disclosure further provides an electronic device, comprising:

a memory, wherein a computer program is stored thereon; and

a processor configured to execute the computer program in the memory to implement the steps of the interaction method of the virtual robot.

It is worth noting that, the electronic device can be used as a control apparatus of the virtual robot, or the virtual robot can also be operated on the electronic device, which is not limited in the present disclosure.

FIG. 8 is a block diagram of the above electronic device according to an embodiment of the present disclosure. As shown in FIG. 8, the electronic device 800 can include a processor 801 and a memory 802. The electronic device 800 can also include one or more of a multimedia component 803, an input/output (I/O) interface 804 and a communication component 805.

The processor 801 is configured to control the overall operation of the electronic device 800 to complete all or a part of the steps of the interaction method of the virtual robot. The memory 802 is configured to store various types of data to support operations at the electronic device 800, for example, these data can include instructions of any application program or method operated on the electronic device 800, as well as relate data of the application program, for example, contact data, sent and received messages, pictures, audio, videos, and so on. The memory 802 can be implemented by any type of volatile or non-volatile storage devices or a combination thereof, such as a Static Random Access Memory (referred to as SRAM), an Electrically Erasable Programmable Read-Only Memory (referred to as EEPROM), an Erasable Programmable Read-Only Memory (referred to as EPROM), a Programmable Read-Only Memory (referred to as PROM), a Read-Only Memory (referred to as ROM), a magnetic memory, a flash memory, a magnetic disk or an optical disk. The multimedia component 803 can include a screen and audio component. The screen can be, for example, a touch screen, and the audio component is configured to output and/or input an audio signal. For example, the audio component can include a microphone for receiving an external audio signal. The received audio signal can be further stored in the memory 802 or transmitted by the communication component 805. The audio component further includes at least one speaker for outputting the audio signal. The I/O interface 804 provides an interface between the processor 801 and other interface modules. The other interface modules can be keyboards, mice, buttons, and the like. These buttons can be virtual buttons or physical buttons. The communication component 805 is configured to perform wired or wireless communication between the electronic device 800 and other devices. Wireless communication includes, such as Wi-Fi, Bluetooth, Near Field Communication (referred to as NFC), 2G, 3G or 4G, or a combination of one or more thereof, so the corresponding communication component 805 can include: a Wi-Fi module, a Bluetooth module and an NFC module.

In an exemplary embodiment, the electronic device 800 can be implemented by one or more Application Specific Integrated Circuits (referred to as ASICs), Digital Signal Processors, (referred to as DSPs), Digital Signal Processing Devices (referred to as DSPDs), Programmable Logic Devices (referred to PLDs), Field Programmable Gate Arrays (referred to as FPGAs), controllers, microcontrollers, microprocessors or other electronic components, for executing the above interaction method of the virtual robot.

The above-mentioned computer readable storage medium provided by the embodiment of the present disclosure can be the above-mentioned memory 802 including program instructions, and the program instructions can be executed by the processor 801 of the electronic device 800 to execute the above interaction method of the virtual robot.

The preferred embodiments of the present disclosure have been described in detail above in combination with the drawings. However, the present disclosure is not limited to the specific details in the above embodiments, various simple modifications can be made to the technical solutions of the present disclosure within the scope of the technical idea of the present disclosure, and these simple modifications all belong to the protection scope of the present disclosure.

It should be additionally noted that, various specific technical features described in the above specific embodiments can be combined in any suitable manner without contradiction. In order to avoid unnecessary repetition, various possible combinations are not additionally illustrated in the present disclosure.

In addition, any combination of various different embodiments of the present disclosure may be made as long as it does not deviate from the idea of the present disclosure, and it should also be regarded as the contents disclosed by the present disclosure.

1. An interaction method of a virtual robot, comprising:
obtaining interaction information input by a user for interacting with the virtual robot;
inputting the interaction information into a control model of the virtual robot, wherein the control model is obtained by training by using interaction information input by a user of a live video platform and behavior response information of an anchor for the interaction information as model training samples; and
performing behavior control on the virtual robot according to behavior control information output by the control model based on the interaction information.

2. The method according to claim 1, further comprising a method for training the control model, comprising:
obtaining the interaction information input by the user and the behavior response information of the anchor for the interaction information from the live video platform; and
using the interaction information input by the user and the behavior response information of the anchor for the interaction information obtained from the live video platform as model training samples to train the control model.

3. The method according to claim 2, wherein the obtaining the behavior response information of the anchor for the interaction information input by the user from the live video platform comprises:
extracting body movement information of the anchor from an anchor video according to a human body posture parsing module; and/or
extracting facial expression information of the anchor from the anchor video according to a facial expression analysis module; and/or
extracting voice information of the anchor from an anchor audio according to a voice analysis module.

4. The method according to claim 2, wherein the control model comprises a deep learning network, the deep learning network is divided into three branches by a convolutional network and a fully connected layers, that is, body movement output, facial expression output and voice output; the interaction information input by the user in the live video platform comprises text information input by the user into a live chat room and picture information of a virtual gift given by the user to the anchor, and the behavior response information comprises body movement information, facial expression information and voice information of the anchor; and
the using the interaction information input by the user and the behavior response information of the anchor for the interaction information obtained from the live video platform as model training samples to train the control model comprises:
using the text information and the picture information of the virtual gift as training inputs to train body movements, facial expressions and voice of the virtual robot.

5. The method according to claim 2, wherein before the obtaining interaction information input by a user for interacting with the virtual robot, the method further comprises:
obtaining preference information input by the user;
determining a target control model matching the preference information from multiple types of control models of the virtual robot;
the inputting the interaction information into a control model of the virtual robot comprises:
inputting the interaction information into the target control model;
the performing behavior control on the virtual robot according to behavior control information output by the control model based on the interaction information comprises:
performing behavior control on the virtual robot according to the behavior control information output by the target control model based on the interaction information.

6. A computer readable storage medium, a computer program is stored thereon, wherein the program implements the steps of the method according to claim 1 when being executed by a processor.

7. An electronic device, comprising:
a memory, wherein a computer program is stored thereon; and
a processor configured to execute the computer program in the memory to implement the steps of the method according to claim 1.
